(19) United States
(12) Patent Application Publication
(10) Pub. No.: US 2006/0112635 A1
(43) Pub. Date: Jun. 1, 2006

(54) Portable hydrogen generator and fuel cell system

(76) Inventors: Laixia Yang, Xi'an (CN); Jiusheng Guo, Fargo, ND (US); Wen Chiang Huang, Fargo, ND (US); Bor Z. Jang, Fargo, ND (US)

Correspondence Address: Bor Z. Jang, 2902 28th Ave. SW, Fargo, ND, 58103, US

(21) Appl. No.: 10/998,223

(22) Filed: Nov. 29, 2004

(51) Int. Cl. B01J 7/00

(52) U.S. Cl. 48/61

(57) ABSTRACT

A hydrogen generator apparatus that delivers a hydrogen stream at a controlled rate to a fuel cell. The apparatus comprises a fuel tank, a wicking material in the fuel tank, a fluid retained in the wicking material, a first disc bounding the wicking material and comprising a hydrophilic membrane for receiving the fluid from the wicking material by a wicking pressure to form a fluid-wetted surface, a second disc having a porous surface area with the second disc being in contact with the first disc with the two discs moveable relative to each other, a catalyst on the porous surface to form a catalyst-coated surface, and hydrogen generated by hydrolyzation of the fluid contacting the catalyst due to a relative motion between the first disc and the second disc. Major features of this apparatus include simplicity, compactness and portability, hydrogen production rate adjustability, reliability, the ability to operate in any orientation and, in one preferred embodiment, a feedback mechanism to automatically maintain a constant pressure supply of hydrogen or constant hydrogen flow rate. The invention also provides an actively or passively controlled power source featuring such a hydrogen generator.

The present invention is a result of a research project supported by the NSF SBIR-STTR Program. The US Government has certain rights on this invention.

### FIELD OF THE INVENTION

This invention relates to a portable hydrogen generator and an electric power source comprising such a hydrogen generator and a fuel cell assembly.

### BACKGROUND OF THE INVENTION

A major barrier to a more widespread utilization of hydrogen fuel cells for powering vehicles or microelectronic devices is the lack of an acceptable lightweight and safe hydrogen storage and supply system. Six conventional approaches to hydrogen storage and supply are currently in use: (a) liquid hydrogen, (b) compressed gas, (c) cryo-adsorption, (d) metal hydride, (e) nano-scale carbon materials, and (f) hollow micro-spheres. However, these technologies still have several major drawbacks to overcome before they can be more fully implemented: (1) low H₂ storage capacity, (2) difficulty in storing and releasing H₂ at a controlled rate (normally requiring a high temperature to release and a high pressure to store hydrogen), (3) high costs, (4) potential explosion danger, and (5) system being bulky, heavy and non-portable. A critical need exists for a portable system that can safely store and release (or generate) hydrogen at a controlled rate at near ambient temperature and pressure conditions.

Most recently, there have been several significant developments in the field of hydrogen generation for fuel cell applications. Of particular interest is the work conducted by Amendola, et al. (U.S. Pat. No. 6,534,033, Mar. 18, 2003) who disclosed a borohydride based solution as a hydrogen source. This solution contains a metal hydride, water, and a stabilizing agent such as NaOH) and, when brought into contact with a catalyst, generates hydrogen gas. Hydrogen generators have been further explored by Amendola and co-workers at Millennium Cell Co. (1 Industrial Way West, Eatontown, N.J. 07724). The results of their recent work may be summarized in the following patent applications (published up to November 2004):
1). S. C. Amendola, et al., “Differential Pressure-Driven Borohydride Based Generator,” U.S. patent application Ser. No. 09/902,899 (filed Jul. 11, 2001).
2). S. C. Amendola, et al., “Portable Hydrogen Generator,” U.S. patent application Ser. No. 09/900,625 (filed Jul. 7, 2001).
3). M. Strizki, et al., “Self-regulating Hydrogen Generator,” U.S. patent application Ser. No. 10/264,302 (filed Oct. 3, 2002).
4). M. Strizki, et al., “Hydrogen Gas Generation System,” U.S. patent application Ser. No. 10/359,104 (filed Feb. 5, 2003).
5). S. C. Amendola, et al., “System for Hydrogen Generation,” U.S. patent application Ser. No. 10/638,651 (filed Aug. 1, 2003).
6). R. M. Mohring, et al., “System for Hydrogen Generation,” U.S. patent application Ser. No. 10/223,871 (filed Aug. 20, 2002).
7). P. J. Petallo, et al., “Method and System for Generating Hydrogen by Dispensing Solid and Liquid Fuel Components,” U.S. patent application Ser. No. 10/115,269 (filed Apr. 2, 2002).

The above prior-art hydrogen generation systems are still very complex, heavy, and/or bulky. Although some of these systems appear to be portable, they are too bulky and heavy to be used for feeding hydrogen fuel to small fuel cell systems for powering microelectronic devices such as a notebook computer, mobile phone, digital camera, and personal digital assistant (PDA). Related art of hydrogen generation prior to 2001 has recently been reviewed by Hockaday, et al. (U.S. Pat. No. 6,544,400, Apr. 8, 2003 and U.S. Pat. No. 6,645,651, Nov. 11, 2003), who disclosed a very interesting self-regulating hydrogen generation system. This system comprises a fuel tank, a wicking material in the fuel tank, a fluid in the wicking material, a hydrophilic membrane bounding the wicking material for receiving the fluid from the wicking material by a wicking pressure to generate a fuel fluid-wetted surface, a surface proximal to the hydrophilic membrane, a catalyst coated on the surface, and hydrogen generated by hydrolyzation of the fluid contacting the catalyst due to reduced internal pressure. Production of hydrogen is initiated by the catalyst-coated surface making contact with the fuel-wetted surface when the internal pressure is low. The hydrophilic membrane is made of an elastic material and, when the pressure is high, the membrane pulls the catalyst-coated surface away from the fuel-wetted surface to stop the hydrogen production process. Such a mechanism of “Contact” or “No Contact” acts to regulate the pressure of the produced hydrogen stream. Although this system is simpler than other aforementioned systems, it still has several drawbacks: It depends upon the operation of an elastic membrane to bend back and forth to initiate or cease the production of hydrogen. Further, bending in a forward direction may require a pressure differential ΔP₁ which could be vastly different from the required pressure differential ΔP₂ for bending in a backward direction. A big difference between ΔP₁ and ΔP₂ means large hydrogen pressure or flow rate fluctuations. The membrane also has to possess an intricate micro-pore structure to allow for hydrogen permeation in such a fashion that it creates a pressure differential between the two sides of the membrane. Such a multi-functional membrane would be difficult and expensive to make. Its poor durability could pose a system reliability problem. Once a membrane with a given material composition, pore structure, shape and size is incorporated into the system, the regulated hydrogen flow rate is essentially fixed and no longer adjustable. This feature would limit the selection of fuel cells that can feed on the hydrogen fuel supplied by such a non-adjustable hydrogen generator.

Hence, an object of the present invention is to provide a simple (non-complex) and portable hydrogen generation system capable of safely and reliably feeding hydrogen fuel to a fuel cell.

Another object of the present invention is to provide a lightweight, compact, and portable hydrogen generation system for fueling small fuel cells used for powering microelectronic devices.

Still another object of the present invention is to provide a hydrogen generator being integrated with a fuel cell for powering or charging a microelectronic device.

### SUMMARY OF THE INVENTION

This invention provides a hydrogen generator that delivers a hydrogen stream at a controlled rate to a device such as a fuel cell. The hydrogen generator comprises a fuel tank, a wicking material in the fuel tank, a fluid retained in the wicking material, a first disc bounding the wicking material and comprising a hydrophilic membrane for receiving the fluid from the wicking material by a wicking pressure to form a fluid-wetted surface, a second disc having a porous surface area with the second disc being in close proximity to or in contact with the first disc with the two discs moveable relative to each other, a catalyst on the porous surface to form a catalyst-coated surface, and hydrogen generated by hydrolyzation of the fluid contacting the catalyst due to a relative motion between the first disc and the second disc.

The hydrogen generator has a mechanism that permits relative motions between the two discs for the purpose of adjusting the catalyst-fuel contact areas and, hence, the hydrogen gas production rate. The major features of this new design include simplicity, compactness and portability, hydrogen production rate adjustability, reliability, the ability to operate in any orientation and, in one preferred embodiment, a feedback mechanism to automatically maintain a constant pressure supply of hydrogen or constant hydrogen flow rate.

The present invention also provides a fuel cell assembly that is directly connected to or integral with a portable hydrogen generator possessing the above features. Such a power source may be equipped with a self-regulating mechanism and control circuit to make an actively-controlled or passively-controlled power source. The system can be used as a battery charger for a range of electronic devices.

### BRIEF DESCRIPTION OF THE DRAWINGS

FIG. 1 Schematic of a portable hydrogen generator 10.

FIG. 2 A cross-sectional view of a portable hydrogen generator.

FIG. 3 Two essential components of a portable hydrogen generator. The first disc 18 comprises at least a hydrophilic, porous zone A′ having a fuel-wetted surface and at least a solid, non-porous zone B′. The second disc 16 has at least a catalyst-coated and gas-permeable zone A and at least a solid, non-permeable zone B.

FIG. 4(a) Zone A′ of the first disc 18 matches zone A of the second disc 16 in such a manner that the catalyst coated on zone A contacts the fuel on the fuel-wetted surface of zone A′ to produce hydrogen via Eq.(1). (b) Zone A′ of the first disc 18 matches zone B of the second disc 16 and zone B′ of the first disc 18 matches zone A of the second disc 16 so that there is no catalyst-fuel contact (hence, no hydrogen being generated) and no liquid fuel leaking out of the fuel chamber 14 (indicated in FIG. 2).

FIG. 5 A fuel cell assembly directly mounted on a surface of a portable hydrogen generator to form a compact power source.

FIG. 6 Schematic of another portable hydrogen generator featuring two discs that can undergo sliding motions relative to each other to adjust the hydrogen production rate.

FIG. 7 Schematic of an actively controlled power source comprising a fuel cell assembly mounted directly on a portable hydrogen generator, and an actuating mechanism along with a feedback control circuit to allow for hydrogen generation rate adjustments on demand according to the voltage, current, and/or power needs in real time.

FIG. 8 A flowchart of a feedback control unit.

FIG. 9 A passively controlled or self-regulated hydrogen generator (“OFF” position). (a) when the generator is not in use; (b) when the production rate is maximum (“ON-max.” position); and (c) when the production rate is intermediate (“ON-intermediate” position), with the rate being adjustable and self-regulated.

FIG. 10(a) a self-regulated, rotational disc-type hydrogen generator; (b) an example of the mechanism that enable the self-regulation.

### DETAILED DESCRIPTION OF PREFERRED EMBODIMENTS

The presently invented portable hydrogen gas generator is based on a class of metal hydride solution fuels that have the following features: The water solution of a metal hydride, particularly a complex metal hydride such as NaBH₄, LiBH₄, KBH₄, Al(BH₄)₃, TiFeH₂, or Pd₂H, is quite stable. Some form of catalyst is needed in order for the hydride-water reaction to proceed at an appreciable rate. As a consequence, this reaction is highly controllable and this is one of the great advantages of this system. For example, if NaBH₄ is used as the metal hydride component, the reaction of NaBH₄ with water (according to Eq.(1)) does not normally proceed spontaneously:
NaBH₄+2H₂O→NaBO₂+4H₂(g) (1)

A small amount of basic solution such as NaOH or KOH could make the solution of NaBH₄+2H₂O even more stable. The present invention provides a simple and reliable way of bringing a catalyst into contact with such a fuel solution to produce hydrogen at a controlled, but variable rate in response to the output power requirement of a fuel cell.

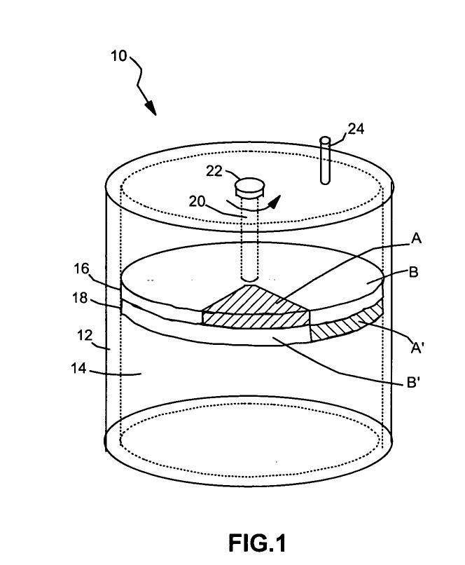

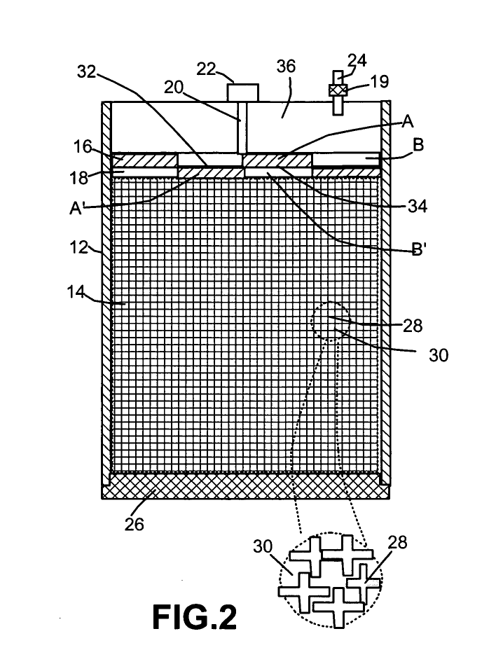

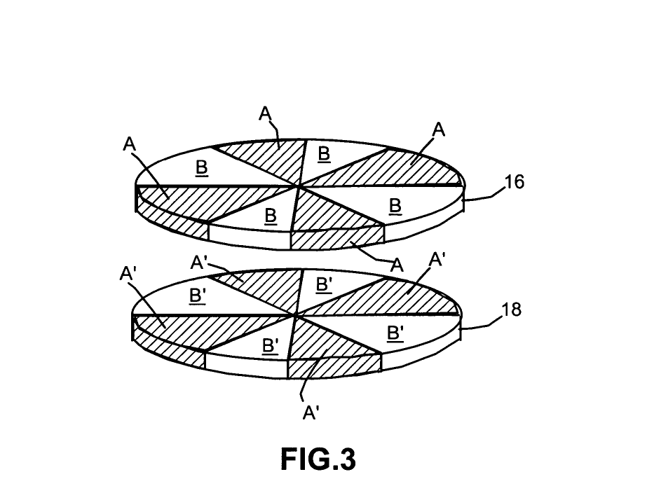

FIG. 1 schematically shows a 3-D perspective of a hydrogen generator 10 according to a preferred embodiment of the present invention. A corresponding cross-sectional view is shown in FIG. 2. As an example, this apparatus has a NaOH-stabilized fuel (e.g., NaBH₄+H₂O+NaOH) 30 held by a wicking material 28 and contained in a chamber 14 of a fuel tank 12 made of a material such as polypropylene (PP), nylon, or a reinforced plastic. This solution, with a pH value greater than 7.0, is very stable under ambient temperature and pressure conditions. When the liquid fuel is brought into contact with a proper catalyst (e.g., Pt or Ru), a hydrogen-producing chemical reaction occurs (Eq.(1)). The wicked fuel is bounded by a first disc 18 that contains at least a porous hydrophilic membrane zone A′ and a solid (non-porous) zone B′. Although only one A′ zone and one B′ zone are shown in FIG. 1, there can be a multiplicity of A′ and B′ zones in one disc. These porous and non-porous zones A′ and B′, preferably in an alternate sequence A′B′A′B′ . . . , are further illustrated in FIG. 3. The solid zones B′ are not permeable to the fuel. The fuel preferentially wicks to and wets the outer fuel-wetted surface 32 of a porous hydrophilic membrane zone A′ (FIG. 2). The preferential wicking is achieved by having a gradient of capillary pressure with the highest pressure at the surface of the fuel-wetted surface 32.

As shown in FIG. 2, a second disc 16, having a shaft 20 and a control knob 22 to facilitate a rotational motion, is rotatable with respect to the first disc 18 and is disposed in close proximity to or in contact with the first disc 18. The second disc 16 comprises at least a gas permeable zone A and a solid (non-permeable) zone B. Again, an alternate sequence ABAB . . . (corresponding to A′B′A′B′ . . . in the first disc) as shown in FIG. 3 is preferred. The bottom surface 34 of zone A is coated with a catalyst which, when brought into contact with the fuel (e.g., fuel on the wetted surface 32), will induce a chemical reaction (e.g., Eq.(1)) to produce hydrogen gases in a well-controlled manner.

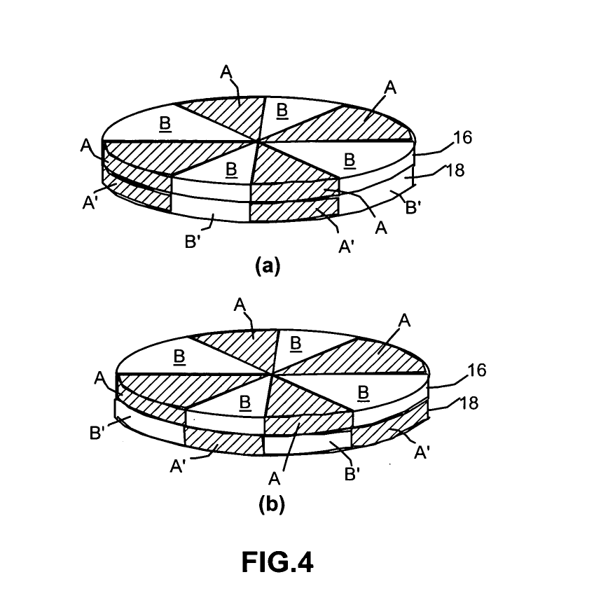

Production of hydrogen is initiated by the catalyst-coated surface 34 making contact with the fuel-wetted surface 32 (FIG. 2) when the second disc 16 is rotated relative to the first disc 18 in such a fashion that a gas-permeable zone A of the second disc 16 matches, partially or fully, a porous hydrophilic membrane zone A′ of the first disc 18 (e.g., A-A′ contacts as shown in FIG. 4(a)). The produced hydrogen permeates through zones A into a gas chamber 36 of the fuel tank 12 (FIG. 2). The hydrogen gas may be allowed to go through a conduit 24 to enter a fuel cell assembly. A control valve 19 may be installed between the fuel tank 12 and the fuel cell assembly.

The present invention provides a convenient approach of bringing a catalyst into contact with a fuel solution in a highly controlled and adjustable manner. In one extreme situation, as shown in FIG. 4(a), zone A′ of the first disc 18 matches zone A of the second disc 16 in such a fashion that the catalyst coated on zone A of the second disc 16 contacts the fuel on the fuel-wetted surface of zone A′ of the first disc 16 to produce hydrogen via Eq.(1). There is a full A-A′ contact with a maximum contact area, generating the highest hydrogen flow rate. In another extreme situation, as shown in FIG. 4(b), zone A′ of the first disc 18 matches zone B of the second disc 16 and zone B′ of the first disc 18 matches zone A of the second disc 16 so that there is no catalyst-fuel contact (hence, no hydrogen being generated) and no liquid fuel leaking out of the fuel chamber 14 (indicated in FIG. 2). The above two situations represent the “ON (maximum)” and “OFF” positions of the hydrogen generator. As intermediate positions, the second disc may be rotated relative to the first disc so that zone A′ of the first disc 18 only partially matches zone A of the second disc 16. The area of such an A-A′ contact is adjustable; i.e., the amount of catalyst-fuel contact area can be adjusted by simply varying the relative orientations or angles of the two discs to vary the hydrogen production rate. This is another major advantage of the presently invented system since this feature makes it possible to provide a desirable hydrogen flow rate to meet the possibly different output power requirements of a fuel cell. The significance of this feature may be further illustrated by referring to an important relation between H₂ usage rate and a required fuel cell output power Pₑ:
H₂ usage rate (kg/sec)=1.05×10⁻⁸×(Pₑ/N_{c}) (2)
where V_{c} is the average operating voltage of unit fuel cells. Eq.(2) indicates that, when a different fuel cell power output is needed, the hydrogen flow rate must be changed accordingly. This is not possible with the portable hydrogen generator system disclosed by Hockaday, et al. (U.S. Pat. No. 6,544,400, Apr. 8, 2003). In the apparatus of Hockaday, et al., once a membrane with a given set of properties is installed into the apparatus, the regulated hydrogen flow rate is essentially fixed (other than with some uncontrollable and undesirable fluctuations) and no longer adjustable. By contrast, the presently invented apparatus allows for manual adjustments of the hydrogen flow rate when a different fuel cell assembly is fed by this apparatus or when the same fuel cell assembly is required to provide a different power output. Furthermore, once an intermediate or maximum flow rate position is selected, hydrogen will be produced at a fairly constant rate without any significant fluctuation.

The catalyst-coated surface 34, shown in FIG. 2, may be attached to or a part of a hydrophobic porous membrane or molecular filter membrane. This membrane may range from a hydrophobic porous membrane to a molecular diffusion membrane such as silicone rubber. The catalyst surface 34 may have a high surface area catalyst such as ruthenium, which is sputter-deposited onto the surface of a polymer felt.

The wicking material 28 (FIG. 2) may comprise a network of interconnected pores in which the fuel solution 30 is retained. The network material may be a sponge material (an absorbent), a stack of fibers, a block of nonwoven materials, etc. The pore sizes may be designed to have a gradient with sizes being changed from larger ones at one end to smaller ones at the opposite end. The capillary pressures in the wicking material network are preferably made to be much greater than the gravitational force to ensure a relatively constant supply of the fuel to the fuel-wetted surface, independent of the orientation of the fuel tank with respect to the gravitation. The wicking material may simply comprise tapered pores or channels in the tank and a capillary pressure gradient created by the tapered pores or channels to facilitate migration of the fuel fluid to the hydrophilic zones of the first disc.

The present apparatus is not limited to the production of hydrogen from a metal hydride solution. A range of hydrocarbon or organic fluids (alone or mixed with water, or in the presence of oxygen), when in contact with a catalyst, produce hydrogen gases. These fluids may be selected from the group consisting of ammonia, liquid methane, methanol, ethanol, hydrazine, and combinations thereof. For instance, the reaction CH₃OH+H₂O→CO₂+3H₂ at room temperature doe not proceed at any significant rate. When the solution of CH₃OH+H₂O is brought into contact with a catalyst such as Pt, Ru, or Pt/Ru, the reaction rate will become appreciable, particularly if an above-ambient temperature is used. The needed heat may come from a fuel cell that feeds on the hydrogen produced by the presently invented hydrogen generator.

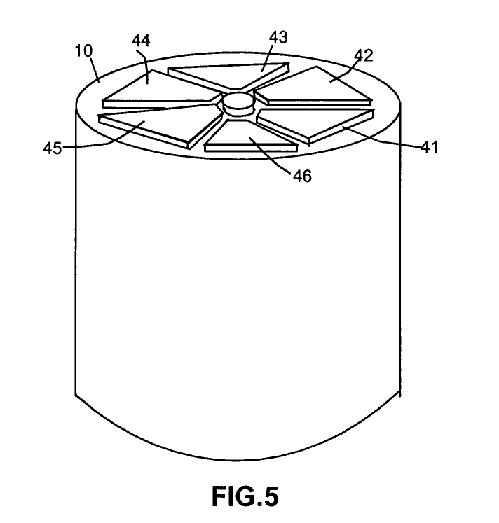

Another preferred embodiment of the present invention is a fuel cell system comprising a presently invented portable hydrogen generator and a fuel cell assembly, preferably with the fuel cell assembly (41-46) and the hydrogen generator 10 integrated together to form a compact power source, as shown in FIG. 5. Each fuel cell unit (41, 42, 43, 44, 45 or 46) comprises an anode (optionally, plus an anode gas diffusion layer, also serving as a current collector) which is fed with hydrogen directly from the hydrogen generator underneath. An opening or channel may be created between the hydrogen chamber of the hydrogen generator and the anode side of a unit fuel cell so that the hydrogen generator may feed hydrogen directly into the anode. Such a feature of directly feeding fuel from a hydrogen generator to a fuel cell assembly obviates the need to have tubing and valves, which otherwise would add weight, costs and complexity to the system.

Each unit fuel cell also comprises an air cathode (optionally connected to a cathode gas diffusion layer or current collector). The air cathode or the gas diffusion layer is open to the outside air to access the oxygen in the air. A thin layer of proton-conducting polymer electrolyte membrane (PEM), having two major surfaces coated with electro-catalysts such as Pt, Ru, or combined Pt—Ru, is sandwiched between the cathode and the anode layer of a unit fuel cell. The unit cells may be electronically connected in series (e.g., the anode side of fuel cell unit 41 being connected to the cathode side of 42 and the anode side of 42 connected to the cathode side of 43, etc.). Although FIG. 5 shows an assembly of six fuel cell units, any number of units may be stacked or assembled together, depending on the voltage and power needs of the external electronic device. These cell units may be connected in series, in parallel, or both. With six units each of 0.65 volts being connected in series, the output voltage will be 0.65×6=3.9 volts, enough to power a mobile phone. The fuel cell assembly may be equipped with a voltage conditioner (e.g., a DC-DC converter) so that the whole power source of a hydrogen generator-fuel cell system can be used as a battery charger.

Due to a simple and compact design (with a minimal amount of non-fuel materials), this hydrogen source-fuel cell package may have higher energy per unit mass, higher energy per unit volume, be more convenient for the energy user, environmentally less harmful, safer than the high performance batteries and less expensive than conventional batteries. Expected specific energy performance levels are between 600 to 6,000 Watt-hr/kg.

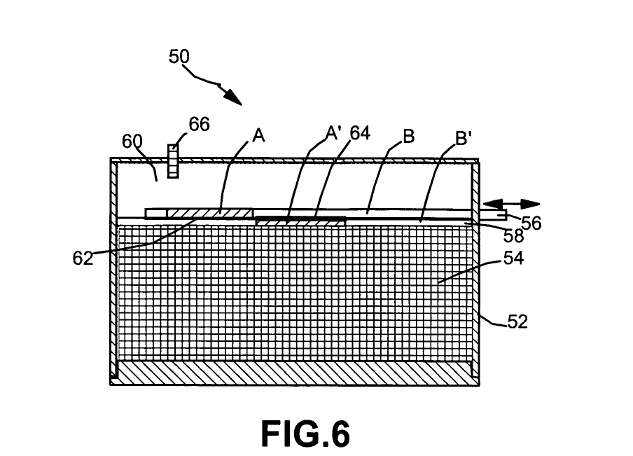

It may be noted that the relative motion between the first disc and the second disc can be a rotation, a translation (e.g., sliding), or a combination of sliding and rotation. The key here is to provide a first relative position where the catalyst and the fuel are separated from each other for no hydrogen production, a second position where the catalyst surface and the fuel surface are in full registry for a maximum hydrogen production rate, and a range of intermediate positions to allow for rate adjustments. For instance, shown in FIG. 6 is another preferred embodiment of the present invention. A portable hydrogen generator 50 has a fuel tank 52 that contains a wicking material 54 for retaining a fuel solution. The apparatus also comprises a first disc 58 and a second disc 56 which can undergo a translation or sliding motion relative to each other. The first disc 58 comprises a hydrophilic, porous membrane zone A′ that allows fuel solution to diffuse through to form a fuel-wetted surface 64. The first disc also comprises a non-porous solid zone B′ that helps to bound the wicking material and fuel solution. The second disc 56 comprises a non-porous solid zone B and a gas-permeable zone A. The bottom surface 62 of zone A is coated with a catalyst. As shown in FIG. 6, the catalyst-coated surface 62 is isolated from the fuel-wetted surface 64. If the second disc 56 slides to the right, the catalyst-coated surface 62 will begin to contact the fuel-wetted surface 64 until the two surfaces 62, 64 fully match each other. By sliding one disc relative to the other, one can easily adjust the contact area between the two surfaces to vary the hydrogen production rate. The hydrogen gas generated will permeates through zone A of the second disc 56 into a gas chamber 60 and through a conduit 66 to feed into a fuel cell (not shown in FIG. 6).

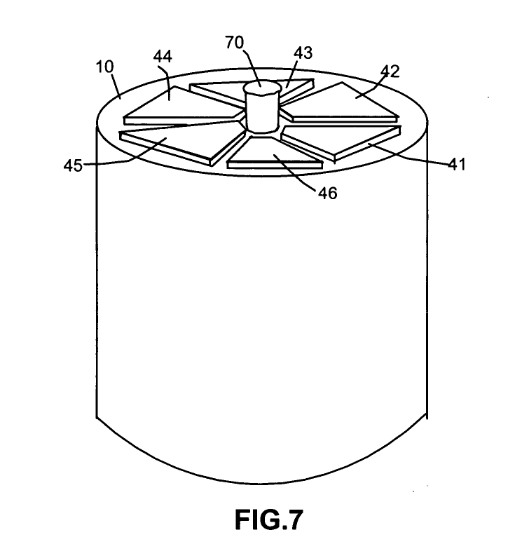

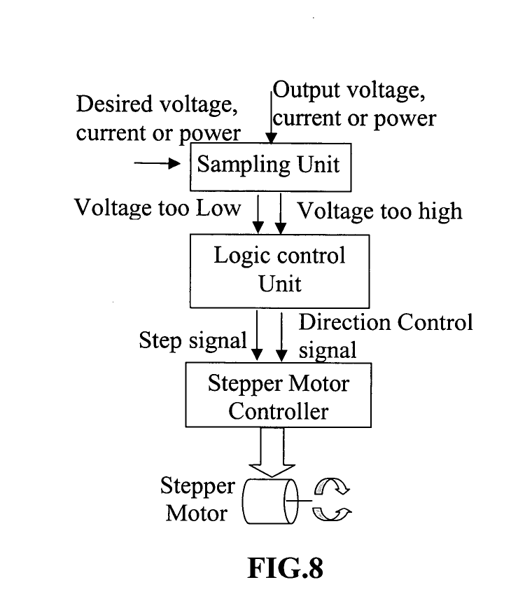

Another preferred embodiment of the present invention, schematically shown in FIG. 7, is an actively controlled power source that comprises a fuel cell assembly-hydrogen generator system similar to that indicated in FIG. 5, but further comprising an actuator mechanism (e.g., a motor 70) and a feedback control circuit (with a flowchart shown in FIG. 8) to regulate the hydrogen flow rate and the resulting power output. The motor 70, responsive to a control signal, is capable of driving a shaft (e.g., 20 in FIG. 2) to rotate one disc (e.g., 16) with respect to the other (e.g., 18 in FIG. 2) to any desired angle. The feedback control circuit may comprise a simple logic circuit that is capable of detecting a fuel cell output parameter such as a current, voltage, and/or power level, comparing the fuel cell output parameter with a predetermined or desired parameter, and then sending out a signal to the motor 70 for adjusting the relative angle between the first disc 18 and second disc 16 (FIG. 2). This permits variations in the hydrogen production rate to meet the power need of an electronic device being powered by a fuel cell (e.g., a mobile phone being re-charged by a fuel cell power source). This type of control circuit is well-known in the art and can be easily and inexpensively manufactured. It may be noted that this actively controlled power source system provides a precisely defined current, voltage and/or power level output since this level is being monitored and adjusted instantaneously in real time without any delay. In contrast, in the apparatus of Hockaday, et al. (U.S. Pat. No. 6,544,400, Apr. 8, 2003), the hydrogen flow rate essentially fluctuates between zero (no fuel-catalyst contact) for a finite duration of time (however small) and a maximum rate (full contact) for another duration of time. This corresponds to the operation of an elastic membrane by bending toward one direction to stop hydrogen production for a while and then bending over toward an opposite direction to re-start the production of hydrogen. Such an operation unavoidably leads to large fluctuations in hydrogen flow rates.

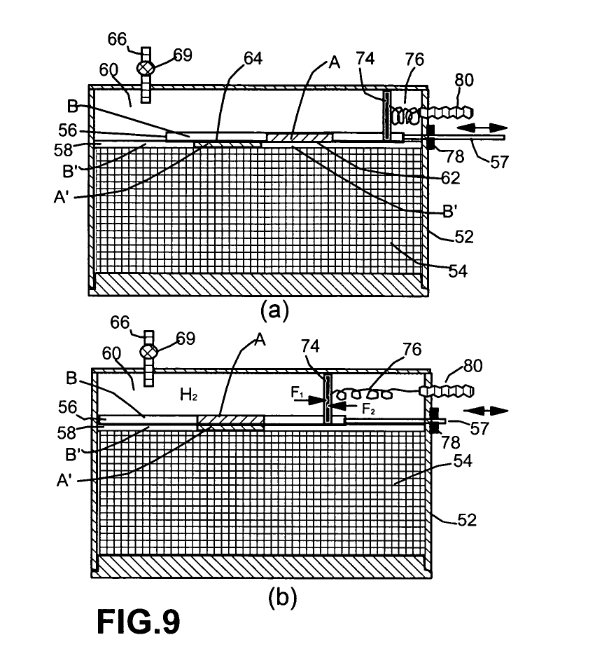

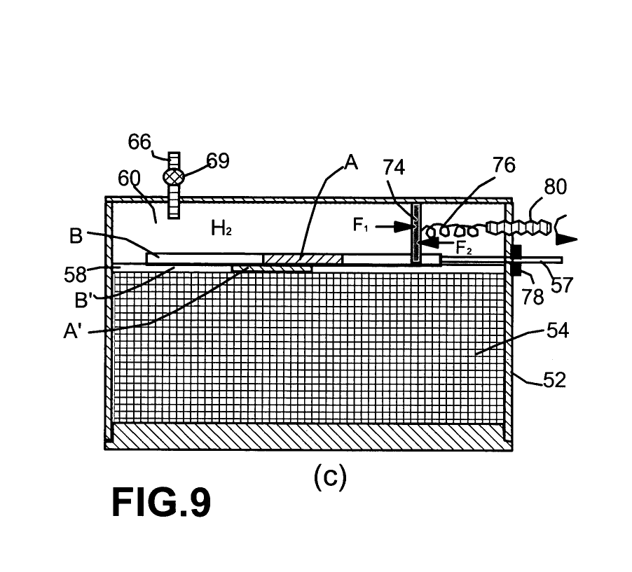

Still another preferred embodiment of the present invention is a passively controlled or self-regulated hydrogen generator as schematically shown in FIG. 9(a), (b) and (c). This apparatus is very similar to the hydrogen generator indicated in FIG. 6. However, the apparatus further comprises a moveable wall 74 connected to or integral with the second disc 56. The moveable wall 74, the second disc 56, and the top and side walls of the fuel tank, in combination, form a hydrogen gas chamber 60 to accommodate the generated hydrogen. The hydrogen gas in the chamber 60 has a gas pressure P₁ exerting a force F₁ on a first surface (left, vertical surface) of the moveable wall 74. The gas chamber is in fluid communication with a conduit 66 and a valve means 69 that can be adjusted to vary the hydrogen gas flow rate and, hence, the gas pressure P₁. The moveable wall 74 is equipped with counteracting force means (e.g., a compressed air chamber to the right of the wall 74 or, preferably, a spring 76) exerting a force F₂ on a second surface (right, vertical surface) of the moveable wall opposite to the first surface. The magnitude of the force differential (F₁−F₂) drives the relative motion between the first disc and the second disc.

When the hydrogen generator is not in use, as shown in FIG. 9(a), a connecting rod 57 attached to or integral with the second disc 56, is locked by a latching mechanism 78 at such a position that the gas-permeable zone A of the second disc 56 matches a solid zone B′ of the first disc 58 so that the fuel solution retained by the wicking material 54 will not leak into the gas chamber 60 and the catalyst-coated surface 62 of zone A is isolated from the fuel-wetted surface 64 of zone A′. No hydrogen is produced in this situation.

When it is desired to begin the production of hydrogen, as shown in FIG. 9(b), the latching mechanism 78 is unlocked and the spring 76 is recoiled to drive the second disc 56 to the left so that A matches A′ to ensure a full contact between a catalyst-coated surface and a fuel-wetted surface. Hydrogen is produced and then permeates into the gas chamber 60, building up a pressure P₁ in the chamber 60. If the valve 69 is open, hydrogen will flow out of the conduit or pipe 66 to feed into a fuel cell, for instance. The gas pressure P₁ will be relatively low and the second disc 56 will remain stationary to allow for the continuous production of hydrogen at a constant, maximum rate.

If a less-than-maximum flow rate is desired, the flow rate may be reduced by turning down the valve 69 and a gas pressure will begin to build up, with P₁ increasing until it reaches a desired level so that the force differential (F₁−F₂) equals a desired magnitude ΔF. This magnitude ΔF can be varied by adjusting the position of the valve 69 and the spring force F₂. The spring force may be adjusted by, for instance, implementing a spring force-adjusting means such as a screw 80 (FIG. 9(c)) which can advance into or out of the space that houses the spring. If the force differential exceeds ΔF, the second disc 56 will be forced to move to the right, thereby reducing the A-A′ contact area, resulting in a reduction in the hydrogen production rate. This reduction in hydrogen production rate, in turn, reduces the chamber pressure and, hence, the force differential (F₁−F₂), resulting in the second disc sliding to the left slightly. These procedures are quickly proceeded or repeated to ensure that (F₁−F₂)=ΔF. Hence, this design provides a self-regulated, non-complex, compact and portable hydrogen generator for portable applications. Again, a fuel cell may be mounted on this hydrogen generator and may feed on the hydrogen generated therefrom. This self-regulated apparatus is fundamentally different from that of Hockaday, et al. (U.S. Pat. No. 6,544,400, Apr. 8, 2003) in many ways. For instance, as cited earlier, the hydrogen production rate in the Hockaday apparatus suffers from large fluctuations between completely “ON” and completely “OFF” positions. By contrast, each self-adjustment step in our apparatus is very small since the A-A′ contact area varies between zero and a maximum with an essentially infinite number of intermediate positions inbetween these two extremes. Further, the hydrogen flow rate in the Hockaday apparatus is not adjustable although the flow rate fluctuates; it fluctuates in an un-controllable and undesirable manner. By contrast, the screw 80 in our apparatus allows us to adjust the spring force at will. The possibility to vary the valve position and spring force makes the presently invented apparatus so much more versatile and flexible.

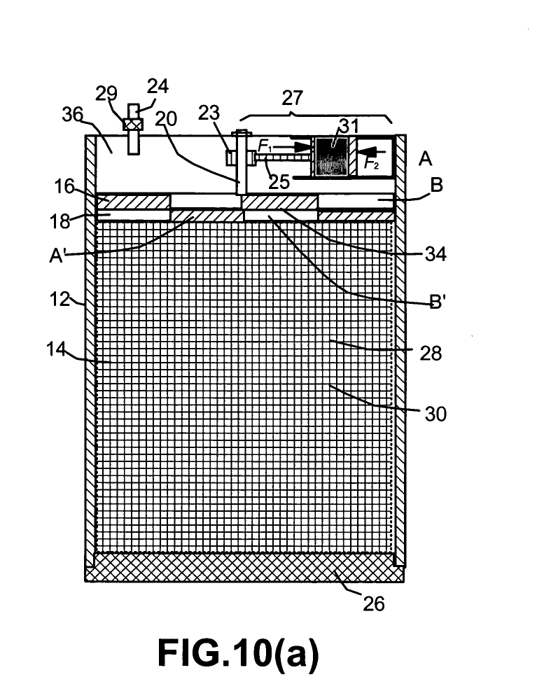

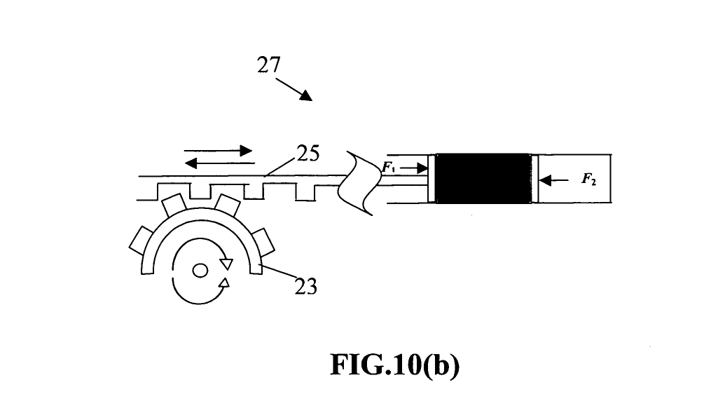

Another preferred embodiment of the present invention is a self-regulated, rotational disc-based portable hydrogen generator, schematically shown in FIG. 10(a). This is similar to the apparatus shown in FIG. 2 with an added control mechanism 27 (further illustrated in FIG. 10(b)) that enables the self-regulation function. This mechanism features a shaft-worm gear combination 23,25 to convert a linear motion into a rotational motion that turns the second disc 16 relative to the first disc 18. This is but one of the many examples of mechanical components that are capable of converting a linear motion to a rotational motion. Again, just like the self-regulation approach depicted in FIG. 9(a)-(c), the force differential (F₁−F₂) proportionately approaching a desired magnitude ΔF governs the self-regulation function. Further similarly, F₂ is provided by an air pressure, a spring (preferably adjustable), or a combination, but an adjustable spring is most preferred. The force F₁, dictated by the hydrogen gas pressure inside the gas chamber 36, can be adjusted by turning a valve 29 (FIG. 10(a)). The “ON (max.)” “OFF” and “ON (intermediate)” positions are achieved in a manner analogous to that of a sliding motion-based self-regulated hydrogen generator described in the previous paragraphs (referring to FIG. 9). In the rotational-motion-based apparatus, member 31 is the moveable wall. Again, such a design provides a precisely regulated hydrogen production rate with very little fluctuation.

It is clear from the above description that the presently invented hydrogen generator system has many special features and advantages, including system simplicity, compactness and portability, hydrogen production rate adjustability, reliability, the ability to operate in any orientation. In one preferred embodiment, a feedback mechanism is added to automatically maintain a constant pressure supply of hydrogen or constant hydrogen flow rate in an active-control or passive-control fashion. The hydrogen generator and a fuel cell system containing such a hydrogen generator are of particular utility value in terms of powering a micro-electronic device such as a notebook computer, a PDA, a mobile phone, or a digital camera.

1. A hydrogen generator apparatus comprising:
A) a fuel tank, a wicking material in the fuel tank, and a fuel fluid in the wicking material;
B) a first disc bounding the wicking material and comprising a hydrophilic membrane for receiving the fuel fluid from the wicking material by a wicking pressure to form at least a fuel fluid-wetted surface;
C) a second disc having a porous surface area that comprises a catalyst coated thereon to form at least a catalyst-coated surface, wherein the second disc being in close proximity to or in contact with the first disc yet moveable relative to said first disc, and
D) hydrogen generated by hydrolyzation of the fuel fluid contacting the catalyst due to a contact between a fluid-wetted surface and a catalyst-coated surface induced by a relative motion between the first disc and the second disc.

2. The apparatus of claim 1, wherein the first disc comprises at least a fluid-wetted surface region and a fluid-free solid region and the second disc comprises at least a catalyst-coated surface region and a catalyst-free solid region in such a fashion that a relative motion between the first disc and the second disc acts to vary a contact area between a fluid-wetted surface region and a catalyst-coated surface region for adjusting a hydrolysis reaction rate or hydrogen production rate proportional to a need for the hydrogen.

3. The apparatus of claim 1, wherein the first disc comprises a plurality of fluid-wetted surface regions and fluid-free solid regions positioned in an alternate sequence and the second disc comprises a plurality of catalyst-coated surface regions and catalyst-free solid regions positioned in an alternate sequence in such a fashion that a relative motion between the first disc and the second disc acts to vary a contact area between said fluid-wetted surface regions and said catalyst-coated surface regions for adjusting a hydrogen production rate proportional to a need for the hydrogen.

4. The apparatus of claim 1, further comprising an actuator to control a relative motion between the first disc and the second disc.

5. The apparatus of claim 1, wherein said wicking material comprises a network of interconnected pores to accommodate the fuel fluid.

6. The apparatus of claim 5, wherein said pores have a pore diameter gradient for creating a capillary pressure gradient.

7. The apparatus of claim 1, wherein said wicking material comprises tapered pores or channels in the tank and a capillary pressure gradient created by the tapered pores or channels.

8. The apparatus of claim 1, wherein the fuel fluid comprises a hydride selected from the group consisting of NaBH₄, LiBH₄, KBH₄, Al(BH₄)₃, TiFeH₂, Pd₂H and combinations thereof.

9. The apparatus of claim 1, wherein the fluid comprises a solution of NaBH₄+H₂O.

10. The apparatus of claim 1, wherein the fluid comprises a chemical hydride in solution producing the hydrogen on contacting the catalyst.

11. The apparatus of claim 1, wherein the fluid comprises a solution of NaBH₄+NaOH+H₂O or a solution of KBH₄+KOH+H₂O.

12. The apparatus of claim 1, wherein the fluid comprises a hydrocarbon or organic fluid.

13. The apparatus of claim 1, wherein the fluid comprises a hydrocarbon or organic fluid selected from the group consisting of ammonia, liquid methane, methanol, ethanol, hydrazine, and combinations thereof.

14. The apparatus of claim 1, wherein the catalyst is Pt and/or Ru.

15. The apparatus of claim 1, wherein the wicking material comprises an absorbent material.

16. An electric power source comprising a hydrogen generator apparatus as defined in claim 1 and a fuel cell in a receiving relation to said apparatus to receive hydrogen fuel produced therefrom.

17. The power source of claim 16, wherein said fuel cell is mounted on said fuel tank.

18. The power source of claim 16, further comprising an actuator driven by said fuel cell to activate a relative motion between the first disc and the second disc to adjust a hydrogen production rate.

19. The power source of claim 18, wherein said relative motion is responsive to a power demand of said fuel cell.

20. The power source of claim 18, further comprising a control circuit in control relation to said actuator.

21. The apparatus of claim 1, wherein said relative motion comprises a sliding motion, a rotational motion, or a combination thereof.

22. The apparatus of claim 1, further comprising a moveable wall connected to or integral with said second disc, wherein
a) said moveable wall, said second disc, and walls of said fuel tank, in combination, form a hydrogen gas chamber to accommodate said generated hydrogen with a gas pressure P₁ exerting a force F₁ on a first surface of said moveable wall, wherein said chamber is in fluid communication with a conduit and a valve means;
b) said moveable wall is equipped with counteracting force means exerting a force F₂ on a second surface of said moveable wall opposite to said first surface; and
c) a force differential of (F₁−F₂) drives a relative motion between the first disc and the second disc to vary a contact area between a fluid-wetted surface and a catalyst-coated surface to regulate a hydrogen production rate.

23. The apparatus of claim 22, wherein said counteracting force means comprise a spring, a compressed air chamber, or a combination thereof.

24. The apparatus of claim 22, wherein said valve means is adjustable and is adjusted to vary said force F₁.

25. The apparatus of claim 22, wherein said counteracting force means comprise a spring being connected to a spring force-adjusting means to adjust said F₂.

26. The apparatus of claim 22, wherein said relative motion is a sliding motion, a rotational motion, or a combination thereof.

27. An electric power source comprising a hydrogen generator apparatus as defined in claim 22 and a fuel cell in a receiving relation to said apparatus to receive hydrogen fuel produced therefrom.

28. The power source of claim 27, wherein said fuel cell is mounted on said hydrogen generator apparatus.
